(19) United States
(12) Patent Application Publication
(10) Pub. No.: US 2021/0310542 A1
(43) Pub. Date: Oct. 7, 2021

(54) POWER TRANSMISSION SYSTEM WITH AT LEAST ONE ENGAGEMENT COMPONENT AND DIVIDED GEAR WHEELS

(71) Applicant: Leonidas Kyros Kontopoulos, Frankfurt am Main (DE)

(72) Inventor: Konstantinos Kontopoulos, Frankfurt am Main (DE)

(73) Assignees: Leonidas Kyros Kontopoulos, Frankfurt am Main (DE); Kyros Philippos Kontopoulos, Frankfurt am Main (DE)

(21) Appl. No.: 16/727,963

(22) Filed: Dec. 27, 2019

(51) Int. Cl. F16H 3/089; F16D 11/10; F16H 61/684; F16D 3/12; F16H 63/08; F16H 63/32

(52) U.S. Cl. CPC F16H 3/089; F16D 11/10; F16H 61/684; F16H 2200/0034; F16H 63/08; F16H 63/32; F16D 3/12

(57) ABSTRACT

The present application relates to a divided gear wheel 100, 200, for a power transmission system 1 of an automotive vehicle, to a power transmission system and a method to operate said power transmission system. The power transmission system comprises at least one divided gear wheel that comprises an inner part 130, 230, being engageable with a shaft and an outer part 110, 210, comprising teeth, adapted for torque transmission to another gear wheel. The inner part and the outer part have a common rotational axis, and the inner part is at least partially arranged within the outer part. Further, the inner part is coupled to the outer part by means of at least a set of two elastic elements, so that the inner part is arranged angularly deflectable with respect to the outer part around the common rotational axis. The inner part and the outer part are adapted to rotate with the same angular speed if the elastic elements are fully loaded.

### FIELD OF THE INVENTION

The present application preferably relates to the field of power transmission systems used in a vehicle and in particular to a divided gear wheel for a power transmission system used in a vehicle, to a power transmission system used in a vehicle, to a method to operate a power transmission system used in a vehicle and to an engine comprising a power transmission system.

### BACKGROUND

Power transmission systems (e.g. gearboxes) are adapted by known automotive vehicles, such as trucks, cars, motorbikes or the like, in order to provide a range of speed and torque outputs, which are necessary during the movement of the vehicle.

In order power transmission systems to transfer power smoothly and shift gears quickly, numerous power transmission systems have been developed.

Similar patents to the presented one are published with the following numbers:

In the patent document U.S. Pat. No. 1,162,305/30 Nov. 1915 a divided gear wheels with one elastic element is presented. It is well known that without a synchronizing mechanism the engagement is not possible. This mean that when there is an absence of clutch disks (in my proposal there is no need for clutch disks), the difference in angular velocities between the engaging parts that are going to be engaged have to be significantly small (<20 rpm). Otherwise the engagement via the dog clutch would not take place and the dog clutch teeth will be damaged. Due to the fact that the divided gear wheel has only one elastic element, the spring constant of said elastic element has to be great in accordance to the torque transfer (in case a small spring constant was chosen the elastic element would be plastically deformed). In my proposal the divided gear wheel comprises two elastic elements in a parallel configuration with one element having a small spring constant (adapted to handle about 0.1% of the maximum applied torque) and one having a greater spring constant for handling the maximum load. The first elastic element (small spring constant) contributes to a smooth engagement and the second elastic element (greater spring constant) handles the occurring load.

In the patent document WO 2008/062192/29 May 2008, the inner/outer parts of the divided gear wheel are connected with the help of resilient means, positioned in a in series arrangement to overcome torque peaks that may occur during the engagement and therefore acting as damping elements. The presented method is a passive method to overcome the torque peaks when the engagement takes place.

The engagement takes place when the dog clutch teeth enter the large engagement windows of the inner part of the divided gear wheel and when the dog clutch teeth meet the surface of the inner part of the divided gear wheel, loud grinding noise occurs additionally to the occurring torque peaks. This may damage the divided gear wheel or the dog clutch and this is the reason why resilient means are adopted, but still the danger of an argue of engagement is present, despite the use of resilient means.

In case where engagement means of the engagement component were in accordance with the engagement means of inner part of divided gear wheel instead of large engagement windows was adopted, the dog clutch may refuse to engage or could end up with damaged engagement means (teeth).

When the resilient means are adopted in a series arrangement the applied total load is the same for each one of the resilient elements. As it is well known every elastic element has an allowed deformation limit. If this limit is surpassed the element is plastically deformed and therefore ends up not being operational. Therefor the differences in the spring constant between the resilient means or springs in a series configuration cannot be great.

In my proposal the parallel positioning and the difference in the length of the elastic elements allow for different spring constants that allow the completion of the engagement of the inner part of the divided gear wheel without causing any damage to the engagement means (teeth). Depending on engines torque and shafts acceleration the demanded ratio between first spring's element resistance force during engagement and rotational force needed to handle the maximum load is about 1/1000 in order to have smooth engagement and to have the demanded rotational force in order to handle the load as will be described with details farther on.

In the patent document DE219963 two concentric wheels connected with elastic elements are claimed and not a divided gear wheel. In this patent the softer elastic element is used in order to handle the occurring load and the stiffer elastic element in order to handle any occurring torque peaks. It is a way to overcame torque shocks.

In my proposal there is a parallel positioning in the elastic elements and a difference in length between the elastic elements that have different spring constants. The elastic element with the smaller spring constant that is longer in relation to the elastic element with the greater spring constant after its initial deformation, does not bear any significant load. The handling of the load of the elastic element with the smaller spring constant is about 0.1% of the maximum occurring load and it is used in order to achieve a smooth engagement between the inner part of the divided gear wheel and the engagement component which is torque proof engaged with the assigned shaft. The elastic element that is shorter in relation to the initially deformed elastic element has a greater spring constant and it is assigned with the main handling of the load.

In addition the inner part of the divided gear wheel is partially arranged within the outer part and therefore less space is demanded. The outer part comprises a gear teething adapted to engage with other gear wheels and the inner part comprises engagement means adapted to engage with the dog clutch or any other suitable engagement component.

There are numerous other patent documents, but none of which incorporates a divided gear wheel adapted in a power transmission system, comprising at least one set of two elastic elements wherein the two elastic elements are arranged in a compartment formed by gear wheel parts wherein the set of two elastic elements comprises elastic elements with different spring constants and spring lengths in relation to each other.

The set of two elastic elements can comprise a first longer spring element having a smaller spring constant and a second shorter elastic element comprising resilient means (e.g. rubber block) adapted to transfer the greater part of the occurring load.

Furthermore all of the above mentioned patent documents have large engagement windows in order to have a successful engagement without damaging the gear teeth, but still have the problem of shocking loads and noise during the engagement, beside the great stress that is faced by the engagement components which might end up damaged. Argue of engagement is another problem that these systems can face.

In my proposal, the set of two elastic elements can comprise a first longer spring element having a smaller spring constant and a second shorter elastic element comprising resilient means (e.g. rubber block) adapted to transfer the greater part of the occurring load.

Additionally in my proposal, where the engagement component is supported by the shaft and engages to the inner circumferential surface of the inner part of the divided gear wheel requires much less space and therefore a more compact power transmission system is possible.

### SUMMARY

In order to surpass the aforementioned drawbacks of a power transmission system preferably adapted in a vehicle, our innovation proposes the replacement of the gear wheels with divided gear wheels.

The divided gear wheel is consisted by an inner part, being engageable with a shaft and an outer part, comprising a gear teething. The inner part and the outer part have a common rotational axis. Further, the inner part is at least partially arranged within the outer part and the inner part is coupled to the outer part by means of at least one set of two elastic elements in a parallel configuration, so that the inner part is arranged angularly deflectable with respect to the outer part around the common rotational axis.

The outer part meshes with the provided gear wheel, which is torque proof fixed with an assigned shaft, defining a gear ratio.

The outer part and the inner part comprise supports that “hold” the set of two elastic elements. The inner part and the outer part, form a compartment wherein the set of two elastic elements is placed. As it is obvious the number of compartments and the number of supports is in relation to the received number of sets of elastic elements.

The inner part, which is free to rotate around the assigned shaft, is engageable with a shaft, such as an input or an output shaft. The engagement is temporally and is achieved with the help of an engagement component. Since the engagement is established temporarily, the inner part should comprise engagement means (e.g. teeth) that are adapted to engage with the engagement means of the dog clutch, wherein the dog clutch temporarily fixes the inner part of the divided gear wheel so as to rotate with the assigned shaft. Accordingly, rotational forces and/or torque can be transferred from the inner part to the shaft and vice versa. The engagement means can be provided on an inner circumferential surface of the inner part, facing an assigned shaft. Further, engagement means can be provided on a front face of the inner part of the divided gear wheel. The engagement means can comprise grooves and/or recesses.

As the inner part is deflectable with respect to the outer part and is coupled to the outer part by a set of two elastic elements, differences in angular velocity during a gear ratio changing action can be compensated.

The maximum deflection angle of the inner part is inter alia dependent on the number of sets of two elastic elements used. If only one set of two elastic elements is provided, the maximum deflection angle may be above 180°, e.g. in a range of 180° to 230°. In case of multiple sets of two elastic elements that are arranged evenly distributed in a circumferential direction, the maximum deflection angle, and thus the available engagement time, is reduced.

The set of two elastic elements can be spring elements and may be positioned within a spring compartment, formed by the inner part and the outer part, in between the inner and outer supports. Alternatively each spring can be positioned in a separate compartment but in any case the set of two elastic elements will be positioned in an arrangement that allows the one elastic element to be initially deformed upon deflection of the outer part in relation to the inner part of the divided gear wheel and the deformation of the second elastic element will follow after the progression of the deflection, with the first elastic element being longer in relation to the second elastic element. In particular, the spring compartment can be a closed compartment. Alternatively, the spring compartment may be an open compartment that allows heat exchange and a facilitated maintenance of the springs.

The outer part can transfer rotational force and/or torque to the inner part via the set of two elastic elements and vice versa. When the inner part is angularly deflected with respect to the outer part the corresponding set of two elastic elements is compressed or decompressed, depending on the direction of deflection and the arrangement of the set of two elastic elements.

Two elastic elements are provided with only the first elastic element (longer elastic element) being in constant contact with both the inner and the outer parts of the divided gear wheel. The first elastic element is in constant contact and the second will be in contact after the deflection of one of the inner or outer parts, since it is shorter in relation to the other elastic element. It is going without saying that more than one set of two elastic elements can be adapted with each of the additional sets of two elastic elements behaving similarly to the one described above. The terms shorter and longer, describing the elastic elements consisting each set of two elastic elements, are a reference in the length of the elastic elements when the elements are not loaded by the deflection of one of the inner and outer parts (Neutral position). Therefore the reference length is the installed length of the first spring element and the free length of the other elastic element, when the divided gear wheel is not engaged to the assigned shaft. Furthermore the inner and the outer part are adapted to rotate with the same angular velocity if the set of two elastic elements is fully loaded under the occurring load.

The elastic elements consisting the set of two elastic elements can be spring elements, such a torque springs or a spiral springs, torsional springs, or any other elastic elements such as rubber blocks etc. Further, different types of elastic elements can be combined in a divided gear wheel in order to achieve a desired spring characteristic.

Each set of two elastic elements is consisted by a first and a second spring element, with the spring constant of the first spring element being lower than the spring constant of the second spring element. The first spring element is longer than the stiffer spring element and it will start to be compressed initially upon engagement of engagement means of the dog clutch with the engagement means of the inner part of the divided gear wheel, providing the required time in order to achieve a complete engagement before the second spring element begins to bear load. Alternatively a combination of springs and elastic elements (e.g. rubber blocks) can be used consisting the set of two elastic elements, with the first element that is initially deformed (smaller spring constant) being for example the spring element and the second element being the elastic element (e.g. rubber block with greater spring constant) by which the main handling of the load is being achieved.

Particularly, a first spring element may be partially arranged within a second spring element and may protrude out of the second spring element on a front face, wherein a spring constant of the first spring element will be lower than the spring constant of the second spring element. The exemplary set of spring elements will comprise one spring element having a bigger diameter concentrically placed to a spring element having a smaller diameter. As mentioned above in an alternative configuration each elastic element consisting the set of two elastic elements can positioned in different compartments but always the softer spring element will be in constant contact with both the inner and the outer parts of the divided gear wheel and will be deformed initially, with the deformation of the second elastic element (stiffer) following, after the progression of the deflection of the components and the deformation of the first spring element. The first (longer, softer) spring element is adopted in order not to allow the relative motion between inner/outer part of the divided gear wheel when inner part is not engaged with the assigned shaft, no matter if inner or outer part accelerates or decelerates or both rotate with the same angular velocity (neutral position).

For example when a torsional spring is used the first (softer, longer) spring is preloaded so that:

Tₚᵣₑ≥J*ωₘₐₓ+T_{f}

Where Tₚᵣₑ is the preloaded torque of the spring, J is the moment of inertia of the inner part of the divided gear wheel, ωₘₐₓ is the maximum angular acceleration/deceleration that can be achieved by the divided gear wheel and T_{f} is the torque created by friction forces between the inner part and the assigned shaft. The first preloaded spring is adapted in order to have negligible deformation when the inner part of the divided gear wheel is not engaged, regardless if the divided gear wheel accelerate, decelerate or rotate with a constant angular velocity. As a result when the divided gear wheel is not engaged with the dog clutch, stays in a neutral position with the softer spring element being negligibly deformed, despite any occurring acceleration or deceleration of the divided gear wheel, due to the existence of the preloaded softer spring. Alternatively as a person skilled in the art understands, the so called neutral position can occur without the softer spring being preloaded, but in that case a higher spring constant (k) in comparison to the spring constant of the preloaded spring have to be adopted.

The second spring element is shorter than the first spring element and it will start to be compressed after the completion of the engagement of the engagement components (i.e. dog clutch and inner part of the divided gear wheel). The second spring element is the one that transfers rotational forces and/or torque, handling the occurring load. It is obvious that the softer spring element also transfers some rotational force and/or torque but due to the fact that the spring constant, in relation to the spring constant of the second elastic element, is very small (<<k) the rotational forces and/or torque being transferred via the softer spring element is insignificant, despite the deformation of the elastic element. The spring constant (k) of the second (stiffer) elastic element is in relation to the maximum torque provided by the engine.

As it is apparent, the existence of the softer spring element contributes to a smooth engagement, and the existence of the stiffer spring element contributes to the power transfer after the completion of the engagement.

As a person skilled in the art understands, due to the fact that the moment of inertia of the inner part of the divided gear wheel is very small and friction forces are negligible, a significantly small spring constant (k) and Tₚᵣₑ is demanded, and therefore a smooth effortless engagement between the engagement components (i.e. dog clutch and inner part of the divided gear wheel) can be achieved, without damaging the engagement means (i.e. teeth).

The existence of a set of two elastic elements adapted in a parallel positioning, with the first spring element with a smaller spring constant being initially deformed upon deflection and the deformation of the second elastic element with the greater spring constant in relation to the spring constant of the first elastic element following, is a key feature of the proposed innovation since the role of the two elements is different. The initially deformed element contributes to a smoother engagement and provides the necessary time in order the engagement to take place, and the second elastic element is the one that the transfers the torque according to the occurring load.

As it is well known, every elastic element has a certain deformation limit. When this limit is surpassed, the element loses its elastic characteristics and therefore it is no longer functional.

In my proposal, the positioning of the set of two elastic elements contributes to this feature, due to the fact that the deformation of the first spring element is independent from the deformation of the second elastic element, with the one element being parallel to the other.

In other innovations comprising divided gear wheels, the positioning of the elastic element is in a series configuration and therefore the same force is applied to all the elastic elements of the series. This restricts having a great difference in the spring constants of each element being part of said series, with the danger of plastically deformed elements being present.

In my proposal the parallel positioning of the elastic elements having different lengths and different spring constants allows loading the first spring element independently from the second elastic element. In addition the first spring element transfers a very small amount of the applied rotational force upon deforming, and the second elastic element transfers the greater amount of the applied rotational force.

As already mentioned, published patent documents relevant to the proposed power transmission system exist, like the following:

U.S. Pat. No. 1,162,305/30 Nov. 1915, seems to adapt a compensating gear in a power transmission system but this compensating gear comprises only a single elastic element. By incorporating only one elastic element the smooth engagement is not achievable since the spring constant of this single elastic element is great in order to handle the provided torque. As mentioned before a small spring constant is needed in order to have a smooth engagement and not damaging the engagement means of both the inner part of the divided gear wheel and the engagement means of the engagement component. In case an elastic element with small elastic constant was adapted, the danger of plastic deformation is present as a result a set of two parallel elastic elements has to be adopted.

Another patent document where two parallel positioned elastic elements are adopted is the German patent DE219963. This patent refers to two concentric wheels, and not to gear wheels, being connected via elastic elements. The longer elastic element is the one that transfers the rotational force and/or torque and therefore connects the two concentric wheels and the second shorter elastic element (with the greater spring constant) is positioned in order to “cushion” any sudden torque peaks. The patent document is not related to gear wheels as my proposal, and the partially arranged inner part within the outer part comprise less space.

Another patent document of a power transmission system that incorporates divided gear wheels is the one presented in the International application WO 2008/062192/29 May 2008. In this document, in case engagement means of the engagement component were in accordance with the engagement means of inner part of divided gear wheel instead of large engagement windows was adopted, the engagement means could end up damaged. The large engagement windows are the ones that provide the necessary time for the completion of engagement but an argue of engagement could take place or engagement mean damage can be present. This is the reason why resilient means are included. The resilient means are in a series configuration. As it is well known every elastic element has an allowed deformation limit. That is the reason why the differences in the spring constants cannot be great. As a result if the spring constant of a resilient mean being adopted in a series configuration, is assigned for a smooth engagement (soft spring) the danger exists that the allowed deformation limit is surpassed. In a scenario where the spring constant of the resilient means is sufficient in order not to be permanently deformed, the previously mentioned drawbacks of noise presence and/or damaged engagement means would again being present. Furthermore an argue of engagement can still take place.

As a person skilled in the art understands, since the engagement of my proposal, with the help of an engagement component, takes place with the inner part of the divided gear wheel (which has small inertia) being the one that is engaged, and since the resistance of the soft spring is very small, a quick and smooth engagement can be achieved.

In case where classic gear wheels were used, the inertia would be the inertia of the entire system (i.e. gear wheel, shaft, differential etc.)

The only way to surpass this drawback is by adopting two elastic elements (one longer softer and one shorter stiffer in parallel configuration as presented in my proposal.

The initially deformed elastic element having the very small spring constant allows a smooth engagement and provides the necessary time in order to complete said engagement, and the following deformation of the second elastic element having a greater spring constant in relation to the spring constant of the first elastic element, accompanied by a simultaneous continuing deformation of the first spring element, is the one that transfers the rotational force/torque according to the occurring load.

The objects are further at least partly achieved by a proposed power transmission system, e.g. for an automotive vehicle, that comprises at least one input shaft, supporting input gear wheels and an output shaft, supporting output gear wheels. (An input gear wheel is a gear wheel assigned to the input shaft and an output gear wheel is a gear wheel assigned to the output shaft.) Each of the input gear wheels engages with a corresponding output gear wheel, thereby defining a gear ratio. At least one of the input gear wheels and/or at least one of the output gear wheels of each gear ratio is a torque free divided gear wheel that can be torque fixed to the shaft upon engagement with the help of an engagement component (e.g. dog clutch ring) when desired. The power transmission system further comprises at least one engagement component (e.g. dog clutch ring) that is assigned to the input shaft or the output shaft and to one free to rotate divided gear wheel. The engagement component is arranged axially movable along the assigned shaft to change a gear ratio, wherein the engagement means (teeth) on (exemplary) the face of the engagement component are adapted to engage with the assigned inner part of the divided gear wheel, thereby torque proof fixing the assigned gear wheel with the shaft.

A gear ratio is formed by two gear wheels, wherein a first gear wheel can be a fixed gear wheel, i.e. permanently engaged with a shaft, and a second gear wheel is a free divided gear wheel, i.e. adapted to be temporarily engaged with a shaft with the help of an engagement component. Either of the first or second gear wheels can be an input gear wheel or an output gear wheel. Further, at least one engagement component is assigned per every gear ratio. As the outer part of the divided gear wheel is deflectable with respect to the inner part of the divided gear wheel and as the inner part is coupled to the outer part by means of at least one set of two elastic elements, differences in angular velocity during a gear ratio changing action can be compensated.

The input shaft can be powered by an engine and the output shaft can power the wheels of an automotive vehicle. By engaging the engagement component with an assigned divided gear wheel, the inner part of the divided gear wheel is torque proof fixed to the assigned shaft. By this engagement of the engagement component with the assigned inner part of the divided gear wheel power transfer can be achieved. Accordingly, by engaging different engagement components, different gear ratios can be chosen.

In an initial state, the power transmission system can operate with a first gear ratio selected, with the help of a clutch. Apart from the initial state where a clutch is needed, all of the other gear ratio changing actions take place with an absence of a clutch engagement/disengagement. Accordingly, power is transferred from the input shaft to the output shaft by means of a first pair of gear wheels that define the first gear ratio. A second gear ratio can be defined by a second pair of gear wheels.

The outer part of the divided gear wheel transfers the rotational force and/or torque to the spring elements connecting the outer part and the inner part and as a consequence these spring elements are being compressed, transferring the rotational force and/or torque to the inner part of the divided gear wheel through the elastic elements. Since the inner part of the divided gear wheel is torque proof engaged with the output shaft due to the engagement with the engagement component, power is transferred from the engine to the wheels.

When a gear changing action, from the first to the second gear ratio, has completed, the first pair of gear wheels must not transfer power to the output shaft and the second pair of gear wheels must be engaged, transferring power. The engagement is achieved by means of an engagement component(s) that is assigned to the free divided gear wheel(s) of the second pair of gear wheels. A different engagement component(s) is assigned to the free divided gear wheel(s) of the first gear ratio. In the initial state, the engagement component, by which the divided gear wheel of the second gear ratio will be engaged with, rotates with an angular velocity (the same as the velocity of the assigned shaft since it is torque proof engaged with the assigned shaft via the dog clutch hub) that is different from the angular velocity of the free divided gear wheel that is going to be engaged. A Central Processing Unit (CPU) with the help of according sensors checks the linear position of the engagement component(s) and takes account of engines rotations per minute (rpm), engine speed, selected gear ratio, wheel speed etc., before commanding the gear ratio changing action. A shifting mechanism pushes or pulls linearly the engagement component (assigned to the next gear ratio) in order to be engaged with the desired divided gear wheel that is meant to rotate freely when it is not engaged with the shaft via the dog clutch. When the engagement component is engaged with the desired divided gear wheel the soft spring(s) inside the divided gear wheel starts to compress. At this moment both engagement components in first and second gear ratio are engaged with each divided gear wheel but the one in the first gear ratio has the elastic elements fully compressed and therefore fully bearing load. As the elastic elements on the second gear ratio bear more load, the elastic elements load inside the divided gear wheel of the first gear ratio, begins to decrease and the stored energy is given back to the system. The moment the elastic elements inside the divided gear wheel of the first gear ratio are nearly unloaded (at this moment power is delivered to the output shaft via the second gear ratio), a command is given by the CPU to disengage the engagement component from the first gear ratio. In addition the energy stored in the elastic elements inside the divided gear wheel of the first gear ratio has returned to the system.

In order to change gear downwards (downshifting) for example from second gear ratio to the first gear ratio the following actions must take place. As the engagement component is engaged with the second gear ratio, according to the measurements taken from according sensors, a gear changing action command is given by the CPU.

At the same time a momentary power cut takes place in order to disengage the engaged divided gear wheel and then the engagement of the divided gear wheel of the first gear ratio takes place.

Additionally or alternatively, both of the engagement means (teeth) of the engagement component and the engagement cavities (or vice versa) of the inner part of the divided gear wheel can have trimmed edges, resulting in angled engagement surfaces. This formation of both engaging components results in easier, smoother disengagement/engagement.

The power transmission system can further comprise a control unit that is adapted to command a gear ratio changing action. The control unit can be fully automatic, so as to operate the engine at a desired operating point (BSFC or maximum torque), and/or the control unit can forward user commands so as to allow the user to command a desired gear ratio. In addition specific measuring instruments (i.e. sensors etc.) will be included providing additional data to the control unit.

The objects are further at least partly achieved by a method of operating a power transmission system, the method comprising the following steps when upshifting: Rotating the input shaft and transferring power to the output shaft by means of an initial gear ratio. After collecting and processing the corresponding data, commanding a gear ratio changing action from the initial gear ratio to the following gear ratio. Axially moving the engagement component and thereby engaging the inner part of the divided gear wheel of the following gear ratio, torque proof fixing with the assigned shaft the following inner part of the divided gear wheel, axially moving the engagement component assigned to the previous gear ratio disengaging the inner part of the divided gear wheel of the previous gear ratio. Rotating the input shaft and transferring power to the output shaft by means of the following gear ratio.

When down shifting: Rotating the input shaft and transferring power to the output shaft by means of an initial gear ratio. After collecting and processing the corresponding data, commanding a gear ratio changing action from the initial gear ratio to the previous gear ratio after a momentary power cut. Axially moving the engagement component and thereby disengaging the inner part of the divided gear wheel of the selected gear ratio, engaging the inner part of the divided gear wheel of the previous gear ratio, torque proof fixing with the assigned shaft the inner part of the divided gear wheel of the previous gear ratio. Rotating the input shaft and transferring power to the output shaft by means of the previous gear ratio or vice versa.

Further, in an alternative, during axial moving the engagement component can be guided by helical means and rotated relative to the assigned shaft in order to compensate a difference in angular velocity at the beginning of the commanded gear ratio changing action between the assigned shaft and the gear wheel to be engaged of the following gear ratio. Thus, a smoother gear ratio changing action can be achieved.

In this case the shifting mechanism would have to secure the engagement of the two components with the help of a securing mechanism (e.g. a worm gear mechanism, a hydraulic mechanism etc.).

As a person skilled in the art understands, due to the fact that the inertia of the inner part of the divided gear wheel is small, even without adapting helical guiding means, the engagement for a difference in angular velocities between the engaging components (i.e. inner part of the divided gear wheel and engagement component) does not cause any problems. In addition in common power transmission systems, the inertia is greater in comparison to the inertia of the presented innovation since the entire shaft and gear wheels contribute to the system's inertia. In contrast in the proposed configuration due to the fact that “soft” springs are adapted inside the divided gear wheels, only the inner part of the divided gear wheel that is going to be engaged with the engagement component contributes to the system's inertia.

Since the engagement with the help of an engagement component, takes place only with the inner part of the divided gear wheel, which has a small inertia and due to the fact that the resistance of the softer spring which compresses initially, is very small, the engagement can be direct, resulting in a quick, smooth gear change without damaging the gears and the engagement component.

In case classic gear wheels where used instead of divided gear wheels, the inertia during the gear change would be the inertia of the entire system with an immediate handling of the occurring load, and not the inertia of the inner part of the divided gear wheel with a progressive handling of the occurring load as in my proposal.

As mentioned before, it is going without saying that both of the gear wheels consisting a gear ratio can be divided gear wheels (both engageable or the one engageable and the other constantly engaged), providing additional time for engagement/disengagement, when needed, but always the one divided gear wheel will be torque proof fixed to the assigned shaft and the other free to rotate when not engaged, being engageable by an engagement component.

As a person skilled in the art understands, in reality, springs act as “clutches” and the existence of the “softer” springs, which are longer than the “stiffer” springs, provide the necessary time in order to completely engage/disengage the engagement component with the assigned inner part of the divided gear wheel, while the occurring load from the deformation of the spring is small (due to the small spring constant of the “soft” spring), so there is no need for using a synchromesh configuration and due to the fact that the inertia of the inner part of the divided gear wheel is small.

Other alternatives following the main principle will be explained further on.

In the presented layout the described configuration comprises divided gear wheels with the outer part comprising a spur gear teething mainly adopted in a power transmission system of a vehicle. This is not restrictive since any type of gear teething can be adopted instead of a spur gear teething.

Moreover the engagement can take place with any suitable engagement component and not necessarily with the dog clutch presented which plays the role of the engagement component in the presented configurations.

Furthermore the presented gear changing action can take place with any type of known shifting mechanisms such as mechanic, hydraulic, or electric shifting mechanism.

The objects are further at least partly achieved by an automotive vehicle comprising a divided gear wheel or a power transmission system as described above.

### BRIEF DESCRIPTION OF THE FIGURES

In the following, preferred embodiments of the present invention are described with respect to the accompanying figures.

FIG. 1 is a schematic illustration of a section cut of a gear ratio of a power transmission system according to a first embodiment;

FIG. 2 is a schematic illustration of a section cut of a power transmission system according to a first embodiment;

FIG. 3 is a schematic perspective exploded view of a dog clutch of a power transmission system according to a first embodiment;

FIG. 4 is a schematic perspective view of an inner and outer part of a divided gear wheel according to a first embodiment;

FIG. 5A to C give a schematic illustration of a gear ratio changing action sequence;

FIG. 6D to F give a schematic illustration of a gear ratio changing action sequence;

FIG. 7 is a schematic illustration of a power transmission system according to an alternative configuration;

FIG. 8 is a schematic perspective exploded view of an engagement component, an assigned shaft and divided gear wheel of a power transmission system according to an alternative configuration;

FIG. 9A to B is a schematic illustration of a power transmission system according to an alternative configuration;

FIG. 10 is a schematic perspective view of a shifting mechanism of a power transmission system according to the previously mentioned configurations;

FIG. 11 is a schematic detail illustration of the engagement means of individual parts of a power transmission system according to the previously mentioned configurations;

FIG. 12 is a schematic detail illustration of the engagement means of individual parts of a power transmission system according to the previously mentioned configurations;

### DETAILED DESCRIPTION

As will become apparent from the following, the present application allows to provide a power transmission system that delivers power smoothly and continuously to the wheels when upshifting, without power losses from friction between clutch disks, due to the absence of clutch disk disengagement/engagement in every gear ratio changing action following the first gear ratio.

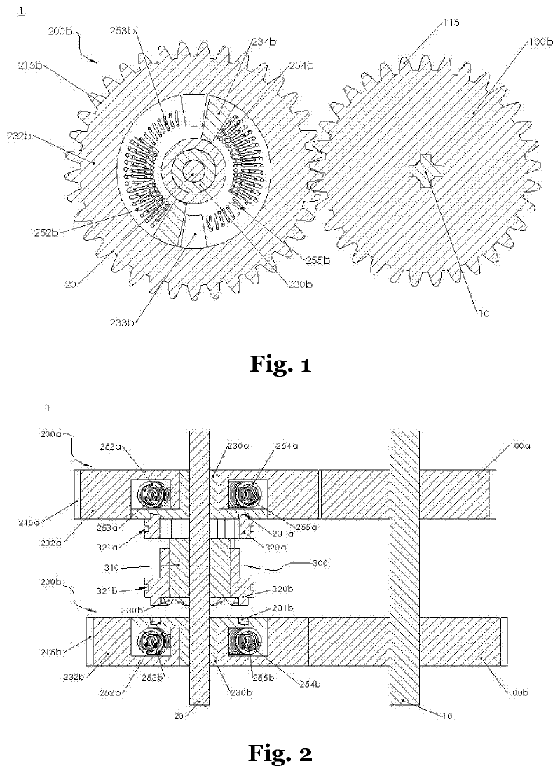

FIG. 1 is a schematic illustration of a gear ratio of a power transmission system 1, defined by a divided gear wheel 200 comprising four spring elements in two spring compartments, supported by the output shaft 20, engaged with a gear wheel 100 supported by the input shaft 10.

The divided gear wheel 200 is consisted of an outer part 232 and an inner part 230 connected to one another by means of four springs 252, 253, 254, 255. The inner part 230 and the outer part 232 have a common rotational axis, and the inner part 230 is at least partially arranged within the outer part 232. Further since two sets of two elastic elements 252, 253, 254, 255 are adapted to couple the inner part 230 and the outer part 232, the inner part 230 is angularly deflectable with respect to the outer part 232 and vice versa.

The outer part 232 of the divided gear wheel 200 has a gear teething 215 on its outer circumference, able to transfer rotational force and/or torque. This gear teething 215 is constantly meshing with the gear teething 115 of the gear wheel 100 which is supported by the input shaft 10 and is constantly engaged with the shaft 10.

The inner part 230 is not constantly engaged with the output shaft 20, but can be torque proof engaged with the shaft only when the engagement means 231 of the inner part 230 interact with the engagement means (teeth) 330 of the engagement component 320 as will be described in further detail later on.

Both inner part 230 and outer part 232 have two spring supports 233, 234, supporting the four springs 252, 253, 254, 255, which are preferably integrally formed with the outer part 232 or the inner part 230, respectively.

The four springs 252, 253, 254, 255, are received in spring compartments, formed by the inner part 230 and the outer part 232. In this exemplary illustration, two sets of two elastic elements, housed in two spring compartments, are adapted as elastic elements, distributed around the inner circumference of the outer part 232. Each set of spring elements is consisted by two spring elements and the first spring element 253 is positioned concentrically to the second spring element 252 which has increased diameter in relation to the first spring element 253. In addition the first spring element 253 protrudes out of the second spring element 252 on a front face and the first spring element 253 has a lower spring rate than the second spring element 252. An analogous configuration is adapted for the other set of spring elements, where the “softer” spring element is the 255 and the “stiffer” is the 254. This “softer” spring assists with an easier, smoother engagement/disengagement between the engagement component 320 and the inner part 230 of the divided gear wheel 200, and provides the needed time in order to fully engage/disengage the engagement component 320 and the inner part 230 of the divided gear wheel 200.

In the presented exemplary configuration, all of the spring elements 252,253,254,255 will compress no matter how the rotating components rotate in relation to each other (clockwise or counterclockwise). Various design approaches can be adapted, always following the basic principle behind the innovation, where the spring elements will be lengthened instead of being compressed. Furthermore additional or fewer sets of elastic elements can be incorporated to the design, with a corresponding redesign of the inner part 230 and the outer part 232.

The inner part 230, also comprises engagement means 231 on its front face where the engagement means (teeth) 330 of the engagement component 320, engage and thereby torque proof fixing the inner part 230 to the output shaft 20. The engagement means 231 in this exemplary configuration are on the front face of the inner part 230. In another alternative configuration the engagement means 231 can be on the inner circumference of the inner part 230 of the divided gear wheel 200. Furthermore the engagement surfaces between the two components can be angled resulting in smoother, easier disengagement, but in any case both engaging surfaces between the engaging parts will be corresponding to each other. Upon engagement, the inner part 230 and the output shaft 20, will be torque proof engaged. The inner part 230 and the outer part 232 of the divided gear wheel 200, rotate with the same angular velocity, when the springs 252,253,254,255 are fully loaded.

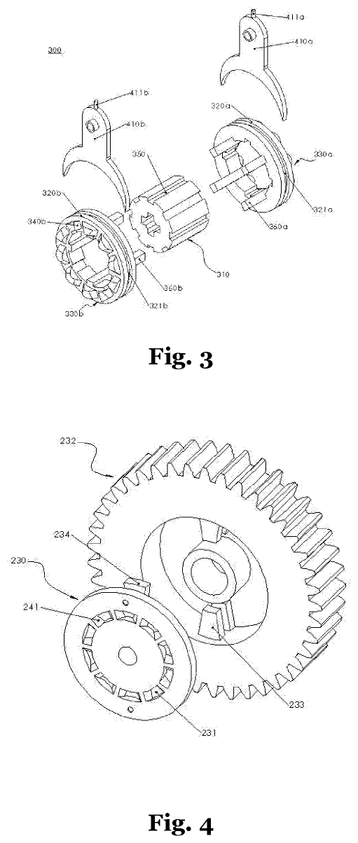

In the presented configuration, a gear ratio is defined by one divided gear wheel 200 and one gear wheel 100, constantly meshing via gear teeth 215 and 115 respectively. The divided gear wheel 200 is engageable with the output shaft 20, engaged upon engagement with the engagement means (teeth) 330 of the engagement component 320. The engagement means (teeth) 330 are not visible in the presented figure but a more clear view follows in FIGS. 2 and 3. The gear wheel 100 is constantly engaged with the input shaft 10 and power can be transferred from one shaft to the other only when the inner part 230 of the divided gear wheel 200, is engaged with the engagement component 320. Power is transferred via the selected gear ratio, from the moment the engagement component 320 engages to the inner part 230 of the divided gear wheel 200. Even when the softer springs compress, a small amount of power is transferred to the system. The springs 252,253,254,255 do not have to be fully loaded in order to transfer torque, but upon full load, both inner part 230 and outer part 232 of the divided gear wheel 200, rotate with the same angular velocity. It is going without saying that both gear wheels forming a gear ratio can be divided gear wheels, resulting in additional features for the configuration. In this scenario, both gear wheels will be divided gear wheels but again one gear wheel will be constantly engaged with the assigned shaft and the other will be free to rotate when not engaged, transferring power only upon engagement with corresponding engagement means. In other words, the inner part of the free divided gear wheel will be engageable with the shaft and the inner part of the other divided gear wheel forming a gear ratio will be constantly engaged with the assigned shaft.

FIG. 2 is a schematic illustration of a horizontal section cut of a gear ratio of a power transmission system 1, illustrating two consecutive gear ratios.

In this depiction, only two consecutive gear ratios are depicted but it is going without saying that the configuration can comprise more than two gear ratios in an analogous layout. In addition all the free divided gear wheels of the configuration, are supported by the output shaft 20. The same goes with the dog clutch 300. In another alternative configuration the free divided gear wheels (and the dog clutches) can alternate to the input shaft 10 and the output shaft 20. In any case and for the presented exemplary layout, as mentioned before, each gear ratio is defined again by a set of a free divided gear wheel and a constantly engaged gear wheel (can be a divided gear wheel as mentioned before).

From this depiction, the positioning of the dog clutch 300 for the presented configuration, is clearer. The dog clutch 300 is in between the presented divided gear wheels (or gear wheels in general when the engageable gear wheels alternate on the input and output shafts) and is consisted by a dog clutch hub 310 and two engagement components 320 providing the engagement means (teeth) 330 which engage to the inner parts 230.

The dog clutch hub is constantly engaged with the assigned shaft (in this configuration the assigned shaft is the output shaft 20) and the engagement component 320 are able to slide axially, engaging or disengaging to the according inner part. Both engagement components 320 are torque proof engaged (but can slide axially) to the dog clutch hub 310 and the face of the one engagement component faces the one gear ratio, while the face of the other engagement component faces the other gear ratio. In addition the engagement components 320, have shifting fork grooves 321 on their outer circumferential surface that house the shifting forks 410, that adjust the axial (in relation to the axis of the assigned shaft) position of the engagement components 320, with the help of a shifting mechanism(s).

As can be seen from this horizontal section cut, gear ratio “a” is selected, since the engagement component 320a is engaged with the inner part 230a. By this engagement the inner part 230a of the divided gear wheel 200a is torque proof engaged with the output shaft 20 (i.e. both output shaft 20 and inner part 230a rotate with the same angular velocity). When springs 252a, 253a, 254a, 255a are fully loaded, both inner part 230a and outer part 232a will rotate with the same angular velocity, and torque transfer will be accomplished exclusively via gear ratio “a” (only one engagement component 320 is engaged with the inner part 230 in the entire configuration, i.e. the gear changing action has been completed).

As can be seen, when the engagement component 320a is engaged with the inner part 230a and the gear ratio changing action is completed, every other engagement component 320 will be disengaged. During gear ratio changing actions, more than one engagement component 320 might be engaged with the corresponding inner parts 230.

In this portrayal, the engagement component 320a, is assigned to engage (and is presented as engaged) with the inner part 230a. The engagement takes places with the interaction between the engagement means (teeth) 330a, positioned on the front face of the engagement component 320a and the corresponding engagement means 231a, positioned on the front face of the inner part 230a.

As a person skilled in the art understands, in order to upshift (change gear from gear ratio “a” to gear ratio “b”), the engagement component 320a will remain engaged with the inner part 230a as the engagement component 320b is moved axially by the corresponding shifting mechanism(s) [the shifting mechanism(s) is controlled by a Central Processing Unit, that after taking account of certain parameters and fed data, commands the shifting mechanism to perform a gear changing action]. When the engagement means (teeth) 330b of the engagement component 320b, initiate to interact with the engagement means 231b of the inner part 230b of the divided gear wheel 200b, the springs 253b and 255b (which are longer and have smaller spring rate in relation to springs 252b and 254b, i.e. springs 252b and 254b are stiffer) will start to compress. At this moment the engagement component 320a is still engaged with the inner part 230a and most of the power is transferred via gear ratio “a” (a relatively small amount of power is transferred from gear ratio “b”, since it is partially engaged with the shaft and the “softer” springs have started to compress). The softer spring elements 253b and 255b, compress initially by the interaction of both inner part 230b and outer part 232b of the divided gear wheel 200b and the compression of the stiffer spring elements 252b and 254b follows. When the stiffer spring elements 252b and 254b compress, the softer spring elements 253b and 255b continue to compress as well, due to the positioning of the four spring elements (252b, 253b, 254b, 255b). As the load being borne by the springs of gear ratio “b” progresses, the load being borne by the springs of gear ratio “a”, decreases, and when the springs of the gear ratio “a” are unloaded, the CPU commands the shifting mechanism(s) to disengage the engagement component 320a. The “softer” springs provide time, so that the engagement component 320, engages completely with the inner part 230 of the divided gear wheel 200.

In order to downshift (change gear from gear ratio “b” to gear ratio “a”), the general outline is generally the same as descripted above. The engagement component 320b is now engaged with the inner part 230b of the divided gear wheel 200b, and the engagement means (dog clutch ring teeth) 330b interact with the engagement means 231b. According measurements are taken from according sensors and a gear changing action takes place [again with the help of a Central Processing Unit and corresponding shifting mechanism(s)].

The moment a downshifting action is commanded, a simultaneous command is being given to the engine in order to momentarily interrupt the power, and the disengagement of the engagement component 320b from the inner part 230b initiates, with a simultaneous engagement of the engagement component 320a to the inner part 230a. When the engagement/disengagement has been completed (linear position sensors will assists, by defining the linear position of the engagement components), the engine will continue supplying power depending on the position of the gas pedal (when the engagement/disengagement is completed, the power supply in relation to the accelerator pedal will follow).

The gear ratios “a” and “b” are exemplary gear ratios. The operation is analogous to any consecutive gear ratio in a power transmission system.

In both upshifting and downshifting, as previously mentioned, a Central Processing Unit (CPU) is the one that commands the shifting mechanism(s) to move the desired engagement component 320 in order to engage (or disengage) to the corresponding inner part 230 [via the engagement means (teeth) 330] of the divided gear wheel 200. The CPU takes account of different measurements (e.g. engine's revolution, vehicle velocity, selected gear ratio, linear position of the engagement component etc.) from according measuring instruments before commanding the gear changing action. The driver can manually command a gear changing action (for example by pressing a button).

As can be understood from the above description in both cases (upshifting and downshifting) when the gear changing action is completed, only one inner part 230 is engaged with the assigned shaft (in the presented configuration output shaft 20) via engagement component 320. During the gear changing action, more than one engagement components 320 can at least be partially engaged with their assigned inner parts 230.

FIG. 3 is a schematic illustration of the components consisted the dog clutch 300 in an exploded perspective layout.

More specifically the dog clutch 300 is consisted by three main components. The first is the dog clutch hub 310 and the other two are engagement components 320, housed to the hub, opposing to each other (i.e. the face of the one engagement component 320a “meets” the one face of the dog clutch hub and the other face of the other engagement component 320b “meets” the other). The dog clutch hub 310 is constantly engaged with the assigned shaft, for example with splines on the inner circumference as depicted in this view. The engagement components 320 are housed to the dog clutch hub 310, constantly interacting with the dog clutch hub 310 and guided by guiding means 350 which are positioned on the outer circumferential surface of the dog clutch hub 310. By the constant interaction of the engagement components 320 with the dog clutch hub 310, both parts are torque proof engaged and rotate with the same angular velocity. Since the dog clutch hub 310 is constantly engaged with the assigned shaft (i.e. rotates with the same angular velocity), both the assigned shaft, the dog clutch hub 310 and the housed engagement components 320 are torque proof engaged and rotate with the same angular velocity. In addition both engagement components 320 can be moved axially by shifting mechanism(s) resulting in engagement (or disengagement) with the assigned part (inner part of the divided gear wheel). The shifting fork(s) 410 are engaged in a rotationally free manner with the engagement components 320a, 320b.

In the presented layout the guiding means—channels 350 are presented as linear grooves/splines (it is obvious that can be either protrusions or cavities). In another alternative guiding means—channels 350 can be shaped as helixes (i.e. formed in a shape similar to a helical gear) with a corresponding change in engagement means 360. As a person skilled in the art understands, in that case, engagement components 320, in addition to the axial movement, will also have a rotational one. As a result when the shifting mechanism(s) pulls (or pushes) the corresponding engagement component 320 in order to engage (or disengage), the engagement component will have an additional angular velocity (increasing or decreasing the angular velocity of the engagement component 320 in relation to the angular velocity of the assigned shaft) depending on how fast (or slow) shifting mechanism(s) actuates the engagement component 320 and the helix characteristics, in order to achieve equal angular velocities between the engaging components (i.e. engagement component 320 and inner part 230 of the divided gear wheel 200). By this feature smoother engagement between the engaging components can be achieved since the engaging components will have same (or similar) angular velocities. The guiding means—channels 350 interact with the engagement means 360 of the engagement component 320, allowing axial (or axial and rotational) movement to the engagement component 320 with constant engagement to the dog clutch hub 310.

Additionally the engaging surfaces 340 can be angled assisting the disengagement (or engagement) of the engagement component 320. It is going again without mentioning that all the changes adapted by the engagement means (teeth) 330 are always made in relation, and with analogous changes, to the engagement means 231 of the inner part 230 of the divided gear 200, resulting in perfect match upon engagement.

In addition every engagement component 320 has a shifting fork groove 321 that houses the assigned shifting fork 410. The shifting fork 410 is not rotatably connected to the engagement component 320 (i.e. the engagement component 320 can rotate with the shifting fork 410 not following the rotation). The shifting fork protrusion 411 is guided in a way that the shifting fork 410 is axially moved, in relation to the axis of the assigned shaft. Since the shifting fork 410 is attached to the engagement component 320, the two are axially (in relation to the axis of the assigned shaft) moved together.

FIG. 4 is a schematic illustration of the inner part 230 and the outer part 232 of the divided gear wheel 200 in a perspective layout.

In this depiction, the engagement means 231 of the inner part 230 of the divided gear wheel 200 can be seen. As mentioned before the engagement means 231 are in accordance with the engagement means (teeth) 330 of the engagement component 320. The engagement means 231 of the inner part 230 are presented as recesses since the engagement means (teeth) 330 of the engagement component 320 have been previously presented as protrusions. In addition the number of recesses and protrusions (or vice versa, or a combination of both in alternative designs) between the two engaging components are in accordance to each other (As a person skilled in the art understands the number of engagement means 231 do not have necessarily be equal with the engagement means (teeth) 330). Furthermore as mentioned before the engaging surfaces are in relation to each other. If, for example, the engaging surfaces 340 of the engagement means (teeth) 330 are perpendicular, in relation to the face of the engagement component 320, the engaging surfaces 241 of the inner part 230 of the divided gear wheel 200 will again be perpendicular in relation to the face of the inner part 230.

In addition in this exemplary configuration spring support 234 of the inner part 230 of the divided gear wheel 200, is positioned between the two elements consisting spring support 233 of the outer part 232 of the divided gear wheel 200, and as a result the two parts (inner part 230 and outer part 232, do not collide to each other). It is going without saying that other forms for both spring supports 233, 234 can be adopted.

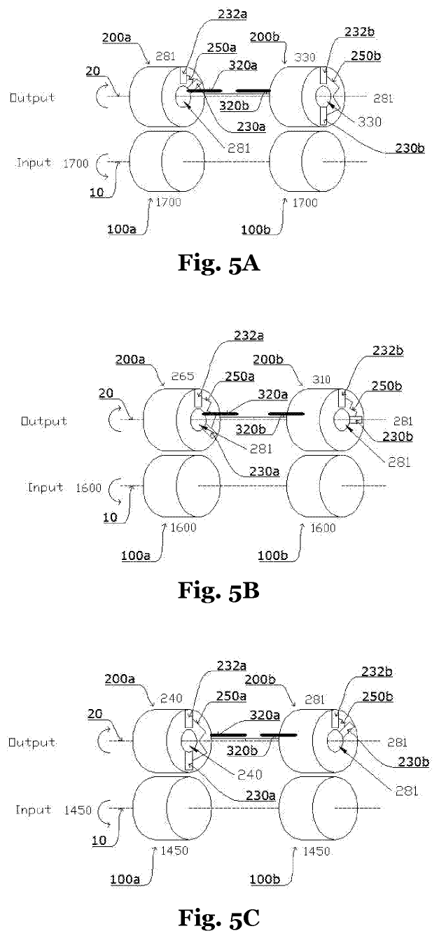

FIG. 5A to C give a schematic illustration of a gear ratio changing action sequence, using random numbers and random gear ratios. More particularly there is an upshifting gear ratio changing action from gear ratio “a” to gear ratio “b”. For this example a heavy vehicle (e.g. truck), with the following gear ratios: gear ratio “a”=6.05, gear ratio “b”=5.16 are selected and the numbers are integral. It is going without saying that the two gear ratios presented are not the only gear ratios of the automotive power transmission system, but are presented in order to explain the gear changing action.

In this set of figures two gear ratios (four gear wheels in total) are presented with a dog clutch 300 in between them in accordance to the previously mentioned layouts. The divided gear wheels 200a and 200b are supported by the output shaft 20 and the gear wheels 100a and 100b are supported by the input shaft 10. Each gear ratio is formed by one divided gear wheel 200 and one gear wheel 100, constantly meshing to each other but can transfer torque to the output shaft 20 only when the divided gear wheel 200 is engaged with the output shaft 20 with the help of dog clutch 300 (engagement components 320 are presented as bold lines, one for each gear ratio). As a consequence gear ratio “a” is formed by divided gear wheel 200a and gear wheel 100a and gear ratio “b” by divided gear wheel 200b and gear wheel 100b.

In FIG. 5A the divided gear wheel 200a is torque proof engaged with the output shaft 20 and gear ratio “a” is selected. At this moment the divided gear wheel 200b is disengaged and rotates, due to the fact that it is meshing with the constantly engaged (to the input shaft) gear wheel 100b. As mentioned before the gear wheels 100a and 100b are constantly engaged with the input shaft 10 and the divided gears 200a and 200b can rotate freely when they are not engaged with the output shaft 20 (with the help of the dog clutch 300), but are torque proof engaged with the output shaft 20 upon engagement. The input shaft 10 rotates, for example, with 1700 revolutions per minute (rpm) and the output shaft 20 rotates with 281 rpm due to the fact that gear ratio “a” is selected (i.e. dog clutch 300 is engaged to gear ratio “a”). Divided gear 200b rotates with 330 rpm, but does not transfer torque to the assigned shaft, since is not engaged with the shaft via an engagement component 320b. The divided gear wheel 200b rotates due to the fact that is constantly meshing with gear wheel 100b, which rotates with 1700 rpm, since is constantly engaged with the input shaft 10.

Springs 250 are fully loaded in both gear ratios “a” and “b”, but the springs 250a are fully compressed (since gear ratio “a” is selected), and the springs 250b are decompressed (since gear ratio “b” is not engaged with the dog clutch 300). In either case (decompression or fully compression) the springs 250 are fully loaded. The difference between the two conditions is the occurring load that results in the according compression. In the case that the spring 250a is fully compressed, the applied load to the spring is great, resulting in larger deformation/compression. In gear ratio “b” the spring is, again fully loaded, but not compressed due to the fact that the applied load is minimum as a result of the unengaged, free to rotate divided gear wheel. As a person skilled in the art understands, the springs of the unengaged free to rotate divided gear wheel, might compress slightly due to the interaction between the connected (via the springs) components (bearing losses, meshing teeth friction, inertia), but since there is no significant resistance (by the unengaged inner part of the divided gear wheel) the term fully decompressed is used. In addition the term fully loaded or fully compressed is used when the springs have altered their length (lengthened or shortened) under the occurring load and the disfigurement is completed.

As can be seen in FIG. 5B a gear changing action (from gear ratio “a” to gear ratio “b”) is commanded and after certain processes in the CPU, the engagement component 320b assigned to the divided gear wheel 200b is moved by a shifting mechanism and engages with the inner part 230b. The engagement component 320a assigned to the divided gear wheel 200a is still engaged with the inner part 230a of the divided gear wheel 200a. As a consequences both inner parts 230 of the divided gear wheels 200a and 200b are engaged with the output shaft 20 via their assigned engagement components 320 (e.g. dog clutch rings).

Now the inner part 230b of the divided gear wheel 200b, rotates with 281 rpm since is now torque proof engaged with the assigned output shaft 20 due to the dog clutch engagement. Since the input rotations from the engine is 1700 rpm and the outer part 232b of the divided gear wheel 200b rotates with 330 rpm, springs 250b inside the divided gear wheel start to compress bearing load.

As a person skilled in the art understands, as the time passes, the load being borne by the springs 250b inside the divided gear wheel 200b increases and at the same time the load being borne by the springs 250a inside the divided gear wheel 200a decreases.

At this moment, both inner parts 230a, 230b of the divided gear wheels 200a, 200b are engaged with the output shaft 20, and therefore power is transferred via both gear ratios “a” and “b”. As it is obvious, as the time passes, more power is delivered to the output shaft 20 via gear ratio “b” and less via gear ratio “a”.

An intermediate moment is presented in FIG. 5B in which, for example, inner part 230b of the divided gear wheel 200b rotates with 281 rpm, outer part 232b of the divided gear wheel 200b rotates with 310 rpm and gear wheel 100b rotates with 1600 rpm. In addition the inner part 230a of the divided gear wheel 200a rotates with 281 rpm and gear wheel 100b rotates with 1600 rpm.

As can be seen due to the difference in angular velocities between the inner parts 230a, 230b of the divided gear wheels 200a, 200b and the angular velocities between their coupled outer parts 232a, 232b of the divided gear wheels 200a, 200b, springs 250a decompress and springs 250b compress.

When all of the power from the input shaft 10 is delivered to the output shaft 20 via gear ratio “b” the springs 250a inside the divided gear wheel 200a of gear ratio “a” will be fully decompressed and the disengagement of the inner part 230a of the divided gear wheel 200a can take place.

In FIG. 5C all of the power is delivered to the output shaft 20 via gear ratio “b”, and as a result springs 250a inside the divided gear wheel 200a are fully decompressed. The CPU is aware of the nearly fully decompressed springs 250a, due to the fact that corresponding position sensors are adapted, and as a consequence, commands a disengagement action to begin, disengaging the inner part 230a of the divided gear wheel 200a.

Now all of the power is delivered via gear ratio “b”. The inner part 230b and the outer part 232b of the divided gear wheel 200b rotate with 281 rpm. In addition gear wheel 100b rotates with 1450 rpm and so does the gear wheel 100a and the engine. Divided gear wheel 200a is ungagged and therefore free to rotate, rotating with 240 rpm due to the meshing with gear wheel 100a.

As can be seen from the above the gear changing action is completed and now the power is transferred via gear ratio “b”, with a continuous, smooth, uninterrupted power transfer from gear ratio “a” to gear ratio “b” and with a corresponding “drop” of rpm to the engine (from the initial 1700 to 1450).

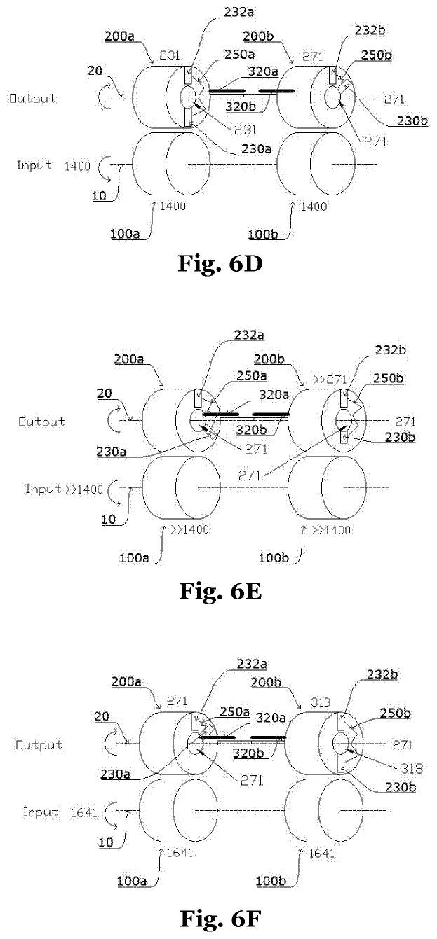

In FIGS. 6D to 6F an example for a gear changing action for a heavy vehicle (e.g. truck) is presented and more specifically a downshifting gear changing action (i.e. from gear ratio “b” to a lower gear ratio “a”).

The configuration is similar to the one described in FIGS. 5A to 5C.

As can be seen in FIG. 6D the inner part 230b of the divided gear wheel 200b is engaged with the output shaft 20 and the divided gear wheel 200a is disengaged and as a result free to rotate. As a consequence gear ratio “b” is selected and the output is 271 rpm with an input of 1400 rpm. Both the gear wheels 100a and 100b rotate with 1400 rpm (due to the constant engagement to the input shaft 10).

Springs 250a are fully decompressed and springs 250b are fully compressed. Inner part 230a and outer part 232a of the divided gear wheel 200a rotate with 231 rpm and inner part 230b and outer part 232b of the divided gear wheel 200b rotate with 271 rpm, due to their meshing with gear wheels 100a and 100b respectively.

A gear changing action from the selected gear ratio “b” to the previous gear ratio “a” (downshifting) is commanded by the CPU.

In FIG. 6E the downshifting action has initiated. CPU commands the engine to a power cut (idling). As a result springs 250b inside the divided gear wheel 200b start to decompress and a disengagement command (from the CPU) can initiate, in order to disengage the inner part 230b of the divided gear wheel 200b. As mentioned before CPU acknowledges that the disengagement is completed from the data acquired by the linear position sensors. At the same time an engagement command (from the CPU) can take place, engaging the inner part 230a of the divided gear wheel 200a with the assigned engagement component 320a and power from the engine is resumed, in relation to the position of the gas pedal.

As a result the inner part 230a of the divided gear wheel 200a rotates with 271 rpm. Since the accelerator pedal is pressed, engine's revolutions increase (input rpm), and as a result the outer part 232a of the divided gear wheel 200a increases its revolutions until reaching 271 rpm. Due to that, springs 250a inside the divided gear wheel 200a begin to compress.

In FIG. 6F the engagement/disengagement has been completed and now both inner part 230a and outer part 232a of the divided gear wheel 200a rotate with 271 rpm and springs 250a inside the divided gear wheel 200a are compressed. As a consequence the input shaft 10 rotates with 1641 rpm, gear wheels 100a and 100b rotate also with 1641 rpm and both inner part 230b and outer part 232b of the divided gear wheel 200b rotate with 318 rpm with springs 250b inside the divided gear wheel 200b being decompressed. Therefore gear ratio “a” is selected with the divided gear wheel 200a engaged with the assigned output shaft 20 and the divided gear wheel 200b disengaged and as a result free to rotate.

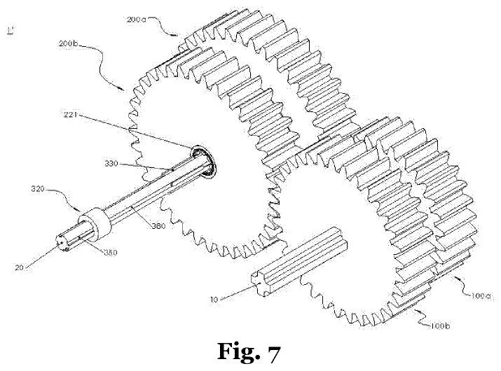

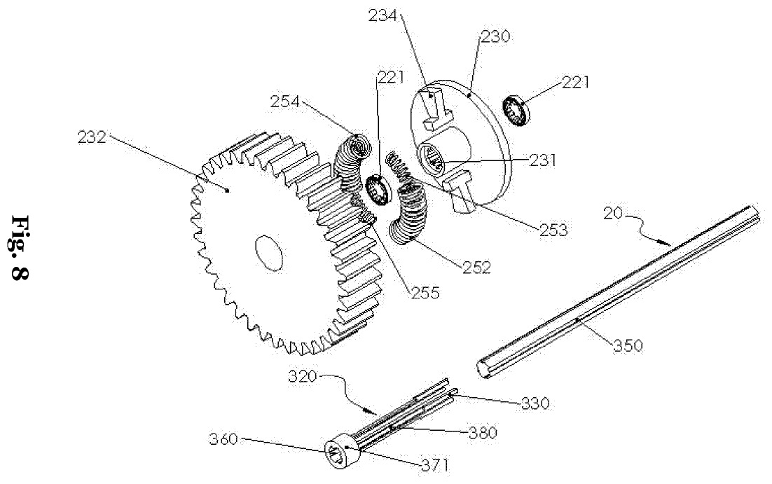

In FIG. 7 an alternative configuration of a power transmission system 1′ is presented, in which the engagement component 320 is directly supported on the assigned shaft (absence of dog clutch hub) and one engagement component 320 is assigned to multiple divided gear wheels. The axial movement of the engagement component 320 by according shifting mechanism(s), engages (or disengages) the inner part 230 of the divided gear wheels 200, and therefore a gear ratio is selected.

The main principles behind this alternative configuration is the same as previously described, where a gear ratio is defined by a set of gear wheels in which at least one gear wheel is a divided gear wheel as described above. In every gear ratio one gear wheel is engageable (engaged upon interaction with the engagement component 320) to the assigned shaft and the other is constantly engaged with the assigned shaft (as mentioned before in an alternative configuration both gear wheels consisting a gear ratio can be divided gear wheels with the one divided gear wheel constantly engaged with the assigned shaft and the other engageable, free to rotate when not engaged). As mentioned before the engageable gear wheel can rotate freely, without transferring torque to the assigned shaft when it is not engaged (to the assigned shaft). The engageable gear wheel is the divided gear wheel.

In this alternative the engagement component 320 is not in between the divided gear wheels but it is, exemplarily, positioned before the gear ratio “b”, as defined by the interaction of gear wheel 100b and divided gear wheel 200b. Output shaft 20 supports output gear wheels 200a, 200b and input shaft 10 supports input gear wheels 100a, 100b. Input gear wheels 100a, 100b are constantly engaged with the assigned input shaft 10 and divided gear wheels 200a, 200b are engaged with the assigned output shaft 20 by interacting with engagement component 320.

Engagement component 320, is axially pushed (or pulled) by according shifting mechanism(s) (with the assistance of a CPU as previously described) and is guided by guiding means 350, which are integrally formed to the output shaft 20 which are (exemplarily) presented as linear grooves (in yet another alternative the grooves can be helical with an analogous operation as previously described, in the guiding means of the dog clutch hub 310, i.e. additional angular velocity upon axial displacement).

As can be seen in more detail in FIG. 8, engagement component 320 is consisted by a bushing portion 371 and at least one engagement component arm 380 extending from the bushing portion 371 and, provided at the distal end, corresponding engagement means (teeth) 330, which are adapted to engage with the engagement means 231 of the inner part 230 of the divided gear wheel 200. Engagement component 320 is torque proof engaged with the assigned output shaft 20 (for example with the help of engagement means 360 on the inner circumference of the bushing portion 371) but can be axially moved [by shifting mechanism(s)]. It is guided (due to the interaction with the engagement means 360) by guiding means 350 (linear as presented or helical in an alternative) integrally formed to the output shaft 20 and engagement means (teeth) 330 adapted to engage with the engagement means 231 of the inner part 230 of the divided gear wheel 200.

As a person skilled in the art understands, the engagement means (teeth) 330 of the engagement component 320, have a length suitable for engaging the inner parts 230. In this alternative for every gear change, a momentarily power interruption from the engine should take place. Alternatively an increased power supply in the shifting mechanism(s) is needed in order to actuate the engagement component (for upshifting or downshifting) as a person skilled in the art understands.

In addition the engagement means 231 are not positioned on the front face of the inner part 230 of the divided gear wheel 200, but are on the inner circumference of the inner part 230. In this alternative the number of engagement means 231 do not have necessarily be in relation to the engagement means (teeth) 330. For example the number of engagement means 231 provided by the inner part 230 can be greater than the number of engagement means (teeth) 330 provided by the engagement component 320, resulting in an easier engagement between the two components.

In addition a set of shaft bearings 221 are provided in order to facilitate the rotation of the inner part 230 in relation to the assigned output shaft 20, and are positioned in between the components, one on each side of the divided gear wheel 200. As it is obvious the inner ring of shaft bearings 221 is shaped in accordance to the engagement component 320 in order to permit the movement of the component, by which the engagement of the inner part 230 of the divided gear wheel 200 is achieved.

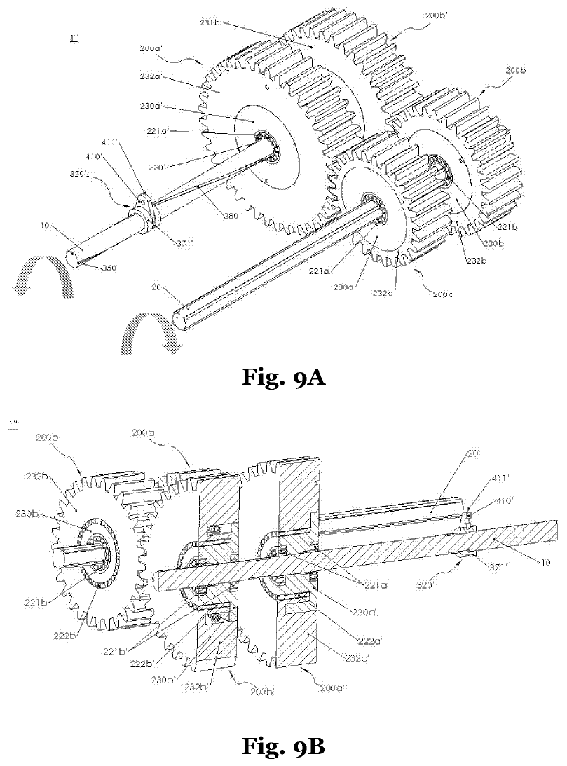

In FIG. 9A to B an alternative configuration, similar to the one presented in FIGS. 7 and 8 is presented.

As can be seen in FIG. 9A the alternative configuration is pretty much alike to the one presented in FIGS. 7 and 8, but in this configuration every gear ratio is consisted by two divided gear wheels 200, 200′, with the divided gear wheel 200 supported by the output shaft 20 and the divided gear wheels 200′ supported by the input shaft 10. Furthermore the divided gear wheel 200′ is provided as a free divided gear wheel and the divided gear wheel 200 is provided as engaged divided gear wheel, with the inner part 230 torque proof engaged with the assigned output shaft 20. As a consequence each gear is consisted by one engageable free to rotate (when is not engaged with the assigned input shaft 10) divided gear wheel and one engaged with the assigned output shaft 20 divided gear wheel 200. In addition the guiding means 350′ are provided as helical guiding means (instead of the previously described linear) with an according modification in the engagement component 320′, that is assigned to the input shaft 10 instead of the output shaft 20 as described in the previous alternative configuration of FIGS. 7 and 8.

As can be seen the engagement component 320′ is torque proof engaged with the assigned input shaft 10, axially movable and able to be engaged with the inner parts 230′ of the divided gear wheels 200′ depending on the needs. Upon engagement the inner part 230′ of the divided gear wheel 200′ is torque proof engaged with the assigned input shaft 10.

As a person skilled in the art understands, due to the helical guiding means 350, when the input shaft 10 rotates, an axial (in relation to the main axis of the input shaft 10) force pushes the engagement component 320′ towards the next gear ratio, and therefore assisting with the engagement of the engagement component 320′ and the assigned inner pars 230′ of the divided gear wheels 200′ when upshifting.

In contrast when we want to downshift the method is similar to the previously described one.

FIG. 9B depicts a more clear view of the divided gear wheels 200′ of gear ratios “a” and “b” in which the position of the shaft bearings 221′ and the inner part bearings 222′ is clearer. As can be seen shaft bearings 221′ (consisted of a set of bearings, one on each face of the divided gear wheel 200) are positioned between the inner part 230′ of the divided gear wheel 200′ and the assigned input shaft 10, and inner part bearings 222′ between the inner part 230′ and the outer part 232′ of the divided gear wheel 200′. The layout of the divided gear wheels 200 is analogous to the one of divided gear wheels 200′. It is worth mentioning that the inner ring of shaft bearings 221′ is shaped with respect to the shape of engagement component arms 380′ (which are shaped according to the formation of guiding means 350′) and to the engagement means 330′ of the engagement component 320′, in order the engagement component 320′ to be able to pass through the shaft bearings 221′, engaging/disengaging the inner part 230′ of the divided gear wheels 200′.

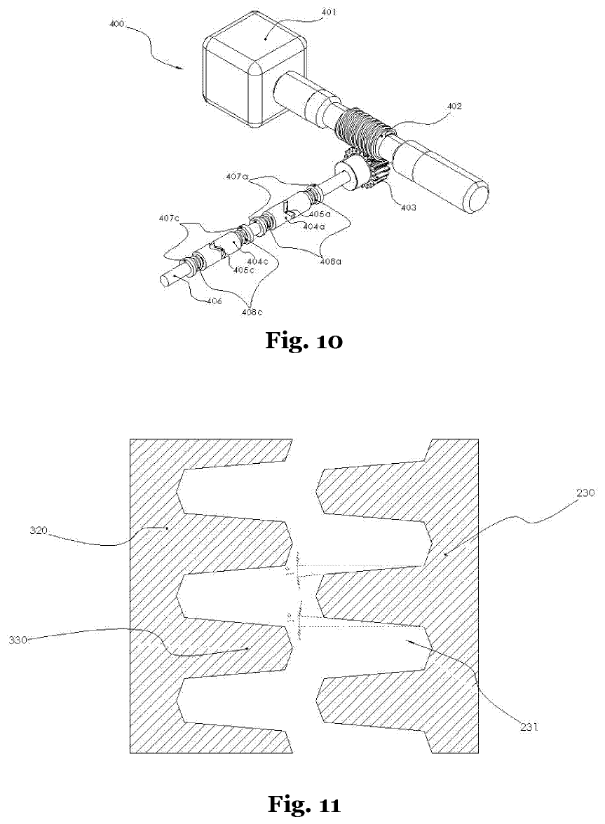

FIG. 10 presents an exemplary shifting mechanism 400 with respect to all the previously presented configurations. As can be seen the exemplary shifting mechanism 400 (it is going without saying that other mechanisms can be adapted) is consisted by a step motor 401 that can rotate (in both directions) the worm shaft 402 and a worm wheel 403, meshing with the worm shaft 402. The worm wheel 403 is torque proof engaged to a splined shaft 406 that supports barrel cams 404 (i.e. when the worm wheel rotates, so does the barrel cams due to the fact that it is connected with splines to the splined shaft 406), which axially (in relation to the main axis of the assigned shaft) move the assigned engagement component 320, through the cam groove 405 and the interaction of the shifting fork protrusion 411 with the cam groove 405. The cam groove 405, guides the provided shifting fork protrusion 411, positioned exemplarily on top of the shifting fork 410.

As a result due to the formation of the cam groove 405, and due to the interaction of the shifting fork protrusion 411 with the cam groove 405, the engagement component 320 can be pushed (or pulled) to (or from) the assigned divided gear wheel 200, depending on the angular position of the barrel cam 404 (and as a consequence the angular position of the worm wheel 403).

In addition due to the worm drive (i.e. the worm shaft 402 meshes with the worm wheel 403), when the worm shaft 402 rotates, so does the worm wheel 403. In contrast the rotation of the worm wheel 403 is not permitted by the worm shaft 402. This feature secures the engagement component 320 in place (i.e. engaged or disengaged to the assigned inner part 230), even if there are axial (in relation to the main axis of the shaft) forces, forcing the engagement component 320 to disengage.

As mentioned before every divided gear wheel 200, has an assigned engagement component 320. As a result and since every engagement component 320 has an assigned shifting fork 410, the number of barrel cams 404, depends on the number of the divided gear wheels 200 selected in the power transmission system. In this depiction only two barrel cams 404 are presented but it is going without saying that more can be adapted. Furthermore preferably, each of the even number of gear ratios (i.e. 2^{nd}, 4^{th}, 6^{th} gear ratio etc.) will share a shaft 406 where the barrel cams 404 are housed and as a result one shifting mechanism 400 will be adapted for the even gear ratios. Consequently one other shifting mechanism 400 will be adapted for the odd number of gear ratios (i.e. 1^{st}, 3^{rd}, 5^{th} gear ratio etc.).

In addition due the splined shaft 406, the barrel cams 404 are provided as axially movable in relation to the main axis of the shaft 406. This feature is provided as a preventive measure in case the engagement means (teeth) 330 of the engagement component 320, do not “match” the engagement means 231 of the inner part 230 of the divided gear wheel 200. In that case although the engagement component 320 is forced to move towards the assigned inner part 230 of the divided gear wheel 200, this movement cannot take place and the provided springs 408 compress. In order for this compression to take place, the one end of springs 408 is on the face of barrel cams 404 and the other end meets the provided, fixed stop rings 407. Therefore even if the engagement means (teeth) 330 of the engagement component 320, do not “match” the engagement means 231 of the inner part 230 of the divided gear wheel 200, springs 408 will compress up till the “match” between the two is allowed. As a person skilled in the art understands when the presented shifting mechanism 400 is adapted, the engagement means 330 are lengthened.

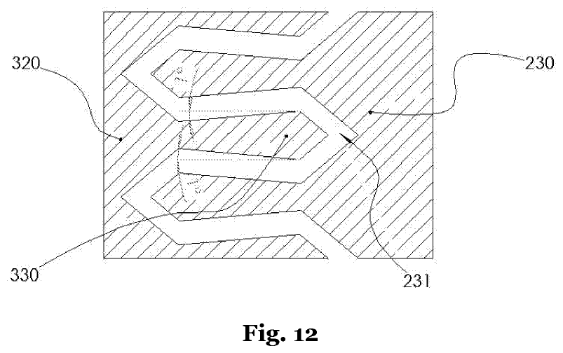

In FIG. 11 a detail schematic illustration of the engagement between the inner part 230 of the divided gear wheel 200 and the engagement component 320 can be seen. In this demonstration, an exemplary engagement means (teeth) 330 formation can be seen. The engagement means (teeth) 330 of the engagement component 320, are shaped with slightly angled side surfaces resulting in additional axial force that assists with the disengagement of the engaging components. Due to the formation of the sides of the engagement means (teeth) 330 and the corresponding formation of the engagement means 231 of the inner part 230 of the divided gear wheel 200, an axial force (in relation to the shaft) is applied to the engagement component 320, forcing the engagement component 320, away from the assigned inner part 230, assisting with the disengagement.

As can be seen the engagement means (teeth) 330 are shaped with an 1° negative angle in both sides of the engagement means (teeth). Due to the negative angle the base of the engagement means (teeth) 330 are wider in relation to the top of the engagement means (teeth). The 1° angle is selected randomly and it is going without saying that any suitable inclination can be chosen.

In FIG. 12 an alternative formation of the engagement means (teeth) 330 is presented. The figure is similar to the previously presented FIG. 11. In this alternative the sides of the engagement means (teeth) 330 are again shaped with a slight angle but the difference in comparison to the previously presented FIG. 11 lays on the fact that the chosen angle is positive, in comparison to the negative one.

As can be seen the sides of engagement means (teeth) 330 are shaped with an 1° positive angle in both sides of the engagement means (teeth). Again the engagement means 231 of the inner part 230 of the divided gear wheel 200 are shaped accordingly. The positive angle results in a narrower base in relation to the wider top of engagement means (teeth) 330.

The negative angle chosen for the sides of the engagement means (teeth) 330 (and the according formation of the engagement means 231 of the inner part 230 of the divided gear wheel 200) results in easier disengagement due to the axial force (in relation to the shaft) applied to the engagement component 320. In case a negative angle is selected, a shifting mechanism like the one presented in FIG. 10 is preferably applied in order to prevent the disengagement of the components when not desired. In contrast when a positive angle is selected, the prevention of disengagement is granted by the design.

It is worth mentioning that jackshaft can be adapted when is needed.

In addition the springs 252, 253, 254, 255 inside the divided gear wheel 200 act as a “channel” transferring force/and or power from the outer part 232 to the inner part 230 (and vice versa), with a corresponding deformation.

The above described power transmission systems, comprising at least one input shaft and at least one output shaft with at least one divided gear wheel in every gear ratio and at least one shifting mechanism that temporarily and/or instantaneously engages two different gear ratios, a CPU that commands a gear changing action after accessing and processing fed data from according measuring instruments and sensors, and a method for operating said power transmission system, allows for a continuous power transfer to the wheels during upshifting, minimizing shifting time and reducing power losses due to clutch disk friction.

### LIST OF REFERENCE SIGNS

1 power transmission system
10 input shaft
20 output shaft
100 gear wheel
115 gear tooth
200 divided gear wheel
215 divided gear wheel tooth
221 shaft bearings
222 inner part bearings
230 inner part
231 engagement means of inner part
232 outer part
233 outer part elastic element (spring) support
234 inner part elastic element (spring) support
241 inner part engaging surfaces
250 elastic element (spring element)
252 elastic element (spring element)
253 elastic element (spring element)
254 elastic element (spring element)
255 elastic element (spring element)
300 dog clutch
310 dog clutch hub
320 engagement component
321 shifting fork groove
330 engagement means (teeth)
340 engaging surfaces
350 guiding means
360 engagement component engagement means
371 bushing portion
380 engagement component arms
400 shifting mechanism
401 step motor
402 worm shaft
403 worm wheel
404 barrel cam
405 cam groove
406 splined shaft for barrel cams
407 stop ring
408 barrel cam springs
410 shifting fork
411 shifting fork protrusion

1. A divided gear wheel (200), for a power transmission system (1) of an automotive vehicle, wherein the divided gear wheel (200) comprises
an inner part (230) being engageable with the assigned shaft (10, 20) and
an outer part (232) comprising a gear teething suitable for the provided meshed gear wheel, adapted for torque transmission to/from the other gear wheel, wherein
the inner part (230) comprises engagement means (231) that are adapted to engage the inner part (230) with the assigned shaft (10, 20),
wherein upon engagement, the inner part (230) is torque proof engaged with the assigned shaft (10, 20), wherein
the inner part (230) and the outer part (232) have a common rotational axis, wherein the inner part (230) is at least partially arranged within the outer part (232), wherein
the inner part (230) is arranged angularly deflectable with respect to the outer part (232) around the common rotational axis, wherein
the inner part (230) is coupled to the outer part (232) by means of at least one set of two elastic elements (252, 253, 254, 255) wherein
each set of two elastic elements (252, 253, 254, 255) is received within at least one compartment formed by the inner part (230) and the outer part (232), wherein
each set of two elastic elements (252, 253, 254, 255) is positioned in a way that, the first elastic element (253, 255) consisting the set of two elastic elements is initially deformed upon deflection of either the inner part (230) or the outer part (232), with the deformation of the second elastic element (252, 254) consisting the set of two elastic elements, following after the completion of the engagement of the inner part (230) with the assigned shaft (10, 20), wherein
the first elastic element (253, 255) and the second elastic element (252, 254) consisting the set of two elastic elements of each set of two elastic elements (252, 253, 254, 255) have different spring constants in relation to each other, with the spring constant of the first elastic element (253, 255) being smaller than the spring constant of the second elastic element (252, 254), wherein
the inner part (230) comprises at least one inner support (234) and the outer part (232) comprises at least one outer support (233) that support each set of two elastic elements (252, 253, 254, 255), wherein
the first elastic element (253, 255) is in constant contact with the inner support (234) and the outer support (233), wherein
the inner part (230) and the outer part (232) are adapted to rotate with the same angular speed if each set of two elastic elements (252, 253, 254, 255) is fully loaded under the occurring load.

2. A power transmission system (1), of an automotive vehicle, comprising:
an input shaft (10), supporting input gear wheels (100, 200);
an output shaft (20), supporting output gear wheels (100, 200), wherein each of the input gear wheels (100, 200) engages with a corresponding output gear wheel (100, 200), thereby defining a gear ratio, wherein at least one of the input gear wheels (100, 200) and/or at least one of the output gear wheels (100, 200) of a gear ratio is a divided gear wheel (200) according to claim 1; and
at least one engagement component (320), assigned to at least one of the shafts (10, 20) and to at least one divided gear wheel (200), wherein the at least one engagement component (320) is torque proof engaged with the assigned shaft (10, 20), configured axially movable along the assigned shaft (10, 20), wherein the engagement means (330) of the at least one engagement component (320) are adapted to engage with/disengage from the engagement means (231) of the inner part (230) of the divided gear wheel (200) thereby torque proof fixing/unfixing the inner part (230) with the assigned shaft (10, 20).

3. The power transmission system (1) according to claim 2, wherein
the at least one engagement component (320) is arranged concentrically to the assigned shaft (10, 20), and has
engagement means (330) adapted to engage with/disengage from the engagement means (231) of the inner part (230) of the divided gear wheel (200), thereby torque proof fixing/unfixing the inner part (230) with the assigned shaft (10, 20),
wherein the at least one engagement component (320) is torque proof engaged with the assigned shaft (10, 20) and can slide axially with the help of at least one shifting mechanism (400), guided by guiding means (350) due to the interaction of the guiding means (350) with the corresponding engagement means (360) of the engagement component (320),
wherein the corresponding engagement means (360) of the engagement component (320) are shaped with respect to the form of the guiding means (350).

4. The power transmission system (1) according to any of claims 2 to 3, comprises at least one engagement component (320) with the engagement means (330) being adapted to engage with the corresponding engagement means (231) of the inner part (230) of the divided gear wheel (200),
wherein the engagement means (330) are provided in accordance to the selected position of the corresponding engagement means (231) of the inner part (230) of the divided gear wheel (200), and have a suitable form in order to deliver the engagement/disengagement.

5. The power transmission system (1) according to any of claims 2 to 4, wherein at least one gear ratio of the power transmission system (1) is defined by two divided gear wheels (200), according to claim 1, where the inner part (230) of the one divided gear wheel (200) is torque proof engaged with the assigned shaft (10,20) and the other inner part (230) of the other divided gear wheel (200) defining a gear ratio is engageable upon interaction with an assigned engagement component (320).

6. The power transmission system (1) according to any of claims 2 to 5, comprises jackshafts with gear wheels, wherein every gear wheel of the at least one jackshaft engages both the input gear wheels (100, 200) and the output gear wheels (100, 200).

7. The power transmission system (1) according to any of claims 2 to 6, further comprising at least one shifting mechanism (400) with a shift actuator, adapted to axially move the at least one engagement component (320), to select/deselect a gear ratio.

8. The power transmission system (1) according to any of claims 2 to 7, further comprising a control unit, position sensors and measuring instruments taking according measurements and providing them to the control unit, which is adapted to command a gear ratio changing action with the provision of respective commands to at least one shifting mechanism (400) after assessing and processing the provided data.

9. A method for operating a power transmission system (1) according to any of claims 2 to 8, the method comprising the following steps:
rotating the input shaft (10) and transferring power to the output shaft (20) by means of an initial gear ratio;
commanding a gear ratio changing action with the provision of respective commands to at least one shifting mechanism (400), after assessing and processing data in a control unit, from the initial gear ratio to a consecutive gear ratio;
axially moving at least one engagement component (320) and thereby engaging the at least one engagement component (320) to the at least one inner part (230) of the at least one divided gear wheel (200) of the consecutive gear ratio, thereby torque proof fixing the at least one divided gear wheel (200) of the consecutive gear ratio with the assigned shaft,
axially moving at least one engagement component (320) and thereby disengaging the at least one engagement component (320) from at least one inner part (230) of the at least one divided gear wheel (200) of the initial gear ratio,
rotating the input shaft and continuously transferring power to the output shaft during the gear changing action, until the entire power is transferred by means of a new gear ratio.

10. The method according to any of the claims 2 to 9, wherein the form of the guiding means (350) forces the torque proof engaged with the assigned shaft (10,20), engagement component (320) to rotate, when moved axially by the shifting mechanism (400), assisting the engagement between the engagement component (320) and the inner part (230) of the divided gear wheel (200).

11. An automotive vehicle comprising a divided gear wheel (200) according to claim 1 or a power transmission system (1) according to any one of claims 2 to 10.
